(19) United States
(12) Patent Application Publication
(10) Pub. No.: US 2001/0048100 A1
(43) Pub. Date: Dec. 6, 2001

(54) Tahoe rescue tool - rescue hoist

(76) Inventor: George Brian Schafer, South Lake Tahoe, CA (US)

Correspondence Address: GEORGE BRIAN SCHAFER, P.O. BOX 14108, SOUTH LAKE TAHOE, CA, 96151, US

(21) Appl. No.: 09/817,294

(22) Filed: Jul. 10, 2001

Related U.S. Application Data
(63) Continuation of application No. 60/194,087, filed on Apr. 3, 2000.

(51) Int. Cl. B66D 1/38

(52) U.S. Cl. 254/336

(57) ABSTRACT

The Tahoe Rescue Tool is a precision lifting hoist that can be used to lift and lower people and equipment with precision and safety not available with other existing designs. The Tahoe Rescue Tool combines a motorized capstan winch with an integral swivel base plate that incorporates guide rollers.

This unique design allows the rope to maintain the required 90 degree angle where the rope leaves the capstan drum, pass through the guide rollers, and then automatically align the rope fastened to the load both horizontally and vertically. This unique design minimizes set-up time required as compared to other capstan hoists that do not incorporate an integral base plate with guide rollers. This advantage allows the Tahoe Rescue Tool to be set up more quickly and used with greater safety making it ideal for use as a rescue hoist or other lifting chores where precision and control are vital.

### DESCRIPTION OF INVENTION

The Tahoe Rescue Tool—Capstan Hoist is a rescue hoist designed to raise and lower rescue personnel and persons needing rescue thereby removing them from harm's way to a place of safety. The hoist can also be used as a precision lifting hoist to remove debris from victims trapped as the result of building collapse or industrial accidents. The hoist uses a capstan instead of a cable allowing, allowing rescuers to use safety ropes of varying lengths and diameters. The hoist is unique because it incorporates a number of new design features that improves upon existing capstan hoist designs.

Ordinary capstan hoists require that the angle at which a rope attached to the load leaves the capstan drum must be exactly ninety degrees or the rope is likely to slip off the capstan causing a loss of control of the load being lowered or lifted. This can result in injury or death of rescue personnel and victims. To overcome this safety hazard, a pulley or lead block is attached to a solid object between the capstan and the load that the rope is passed through to assure that the rope always leaves the capstan drum at a constant ninety degree angle. This also requires an exact placement of the hoist relative to the load that is to be raised or lowered. As a result, capstan hoists are seldom used as rescue hoists because of inherent dangers if the hoist is not positioned and set up perfectly, and setting up a capstan hoist properly is generally too time consuming to be practical.

The Tahoe Rescue Tool—Capstan Hoist, by incorporating new and unique design changes resolves these problems and thereby turns this new capstan hoist into a rescue hoist that can be set up in a fraction of the time and overcomes the inherent safety problems of other capstan hoists. The Tahoe Rescue Tool incorporates a heavy metal plate mounted to the base of the capstan drum. This is designed to rotate 360 degrees around the base of the capstan drum. The plate incorporates metal roller guides that the rope is secured between where the rope leaves the drum towards the load. The result is a capstan hoist that can be set up quickly in any position. The rotating metal plate with integral lead block/roller guide assembly assures that the rope automatically aligns itself with the direction of the load, and assures that the rope leaves the drum at a constant ninety degree angle. By incorporating these new design features, a previously impractical and often dangerous capstan hoist becomes an ideal rescue tool for both raising and lowering rescue personnel and their victims.

The Tahoe Rescue Tool will be manufactured by combining a motor (hydraulic or electric) with a gear head that reduces the motor's revolutions-per-minute to an appropriately slower speed. The gear head design incorporates a heavy metal flange that allows the attachment of a mounting plate and the rotating guide roller/lead block plate. The mounting plate allows mounting the hoist to receiver-type tow hitches commonly found on motor vehicles. A metal capstan drum is then attached to the metal output shaft of the gear head, thus completing the Tahoe Recue Tool—Capstan Hoist assembly.

1. The Tahoe Rescue Tool—Rescue Hoist, consisting essentially of a motorized capstan and a swivel base with integral guide rollers: decreases the time needed to rig the Tahoe Rescue Tool for lifting and lowering duty as compared with other capstan hoists.

2. The Tahoe Rescue Tool—Rescue Hoist, consisting essentially of a motorized capstan and a swivel base with integral guide rollers: eliminates the need for additional guide rollers/lead blocks to maintain control of the load that is being lowered or lifted.

3. The Tahoe Rescue Tool—Rescue Hoist, consisting essentially of a motorized capstan and a swivel base with integral guide rollers: eliminates potential for improperly positioning of guide rollers reducing the potential for loss of control of the rope controlling the load.
